(19) United States
(12) Patent Application Publication
(10) Pub. No.: US 2011/0097170 A1
(43) Pub. Date: Apr. 28, 2011

(54) Drill Bit Extractor

(76) Inventor: Gerald Miller, Covington, LA (US)

(21) Appl. No.: 12/912,469

(22) Filed: Oct. 26, 2010

Related U.S. Application Data
(60) Provisional application No. 61/255,286, filed on Oct. 27, 2009.

(51) Int. Cl. B25B 27/18

(52) U.S. Cl. 408/226

(57) ABSTRACT

An extractor for stuck drill bits. The extractor has an elongated main body with a bore at one end, the bore sized and shaped to fit over the shank of a drill bit. The drill bit shank has a cross section shape with a non-circular feature, such as a slot, a square, triangle, etc. The bore has a cooperative shape, and when engaged on the shank of the drill bit permits transfer of torque between the extractor and the drill bit. The extractor has a torque engaging surface, such as a hexagonal surface, on which a torque device such as a wrench can be engaged, and reverse torque thereby applied to extract a stuck drill bit.

### CROSS REFERENCE TO RELATED APPLICATIONS

This regular patent application claims priority to U.S. Provisional patent application Ser. No. 61/255286, filed Oct. 27, 2009, for all purposes, and said application is hereby incorporated in its entirety by reference.

### BACKGROUND

Many different types of drill bits are used with power drills (such as those driven by electric motors, hydraulic motors, pneumatic, etc.) to drill through all sorts of materials. One type of electric drill not only applies torque, but also impact, to the drill bit—hence the name an “impact” drill. Such drills, and special drill bits, are frequently used to drill through concrete and masonry.

Masonry drill bits generally have a shank (the part that fits in the chuck of the drill) with some sort of interference or non-circular profile or cross section shape, rather than a completely circular cross section, on at least part of the shank. This non-circular cross section shape permits a more efficient torque transfer. The shape may be generally square, triangular, splined, or have a groove into which a projection in the drill chuck fits; or conversely, have a projection which fits into a groove in the chuck. Other means of creating an interference connection may be possible.

In drilling holes in concrete foundations, such as house slabs, it is not unusual for the drill bit to hit metal re-bar or a stone imbedded in the concrete—when that happens, the drill bit generally becomes stuck in place. Reverse torque must be applied to back out and remove or extract the drill bit.

While many power drills have the ability to apply some level of reverse torque, there are frequently limitations to applying reverse torque, either in that the power drill cannot impart sufficient torque to extract the drill bit, too much torque is applied, or the torque is applied too quickly or unevenly, with damage to the drill bit resulting. Often, a technique used in the past is to remove the drill from the drill bit, and apply a wrench directly to the shank of the drill bit. This frequently results in damage to the drill bit, since the wrench is not engaging a compatible cross section shape, as well as being time-consuming.

### SUMMARY

The invention, generally, is an apparatus, namely an adapter or extractor which engages the exposed shank of a stuck or “frozen” drill bit, which permits a wrench, ratchet, or other torque device to engage the apparatus, and apply reverse torque to the drill bit, thereby backing out or extracting the drill bit.

### BRIEF DESCRIPTION OF THE DRAWINGS

FIG. 1 is a perspective view of the extractor.

FIG. 2 is a view from one end (upper end) of the extractor.

FIG. 3 is a view from the opposite end (lower end) of the extractor.

FIG. 4 is a cross section view, along the lines shown in FIG. 2.

FIG. 5 is a perspective view showing the extractor in place to be slid over the shank of a drill bit.

FIG. 6 is a view of the extractor in place on a drill bit.

FIGS. 7-9 show alternate cross section shapes of the bore of the extractor which engages the shank of the drill bit.

### DETAILED DESCRIPTION

The present invention is an adapter or extractor that fits over the exposed end of the drill bit shank and permits a wrench, socket, or other torque device to be properly applied to the extractor. With a torque device on the extractor, left hand torque put on the extractor is transferred to the drill bit, and the drill bit can be backed out and extracted quickly and without damage to the drill bit.

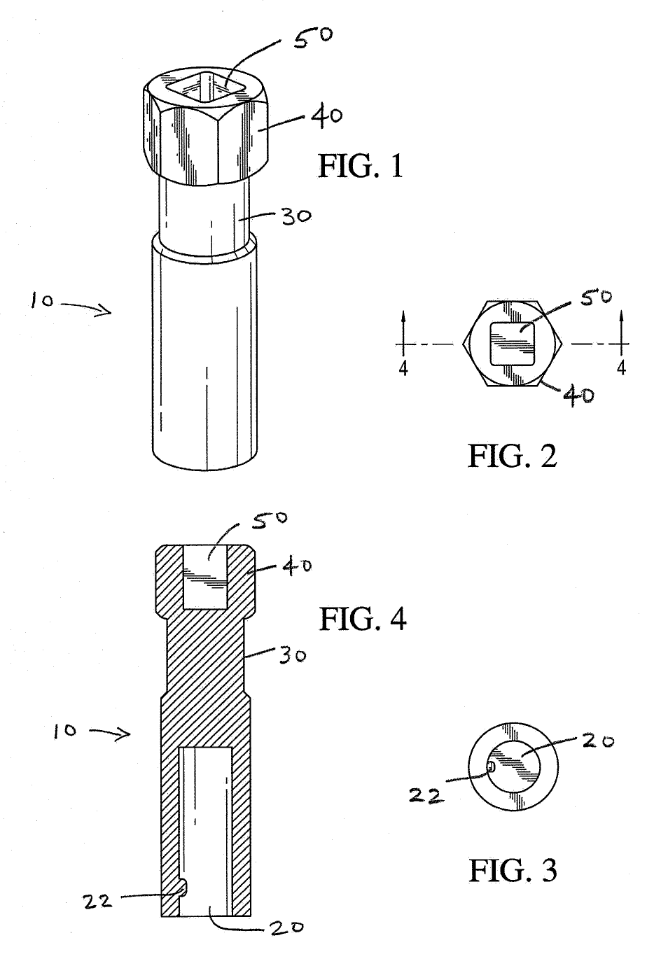

FIG. 1 shows a perspective view of the extractor 10. Extractor 10 comprises a main body 30 with first and second ends and a first bore 20 at one end. In the embodiment shown, as can be readily seen in FIGS. 3 and 4, first bore 20 is generally circular in cross section shape, and a projection 22 protrudes from the wall of first bore 20, to engage a slot in the shank of a drill bit (as is later described), to provide an interference fit to enable torque to be transmitted from the extractor to the drill bit.

Extractor 10 comprises an external surface having a cross section shape adapted to engage a torque device, for example a wrench, such as torque device engaging surface 40, which in the pictured embodiment is a hexagonal shape. It is to be understood that any shape of head which permits easy engagement with a wrench, socket or like tool may be used, such as a square head, two parallel surfaces spaced apart from one another across a diameter of the extractor, such as opposed flats, etc., and the scope of the invention encompasses all such shapes. In addition, the end of extractor 10 opposite the end comprising first bore 20 may comprise a second bore 50, as can be seen in FIGS. 1, 2 and 4. In the pictured embodiment, second bore 50 is generally square in cross section shape, and is sized to accepts a square driver such as on a conventional ratchet wrench, T-handle driver or the like, which may be used in lieu of (or in addition to) a wrench to apply torque to the extractor. It is to be understood that extractor 10 may have both types of torque-engaging surfaces, namely an external cross section shape such as hexagonal torque engaging surface 40 and second bore 50, or only one of the two. A key aspect is that the extractor have some shape to which a torque device (whether it be a wrench, socket, or other device) can be applied, to apply torque to the extractor.

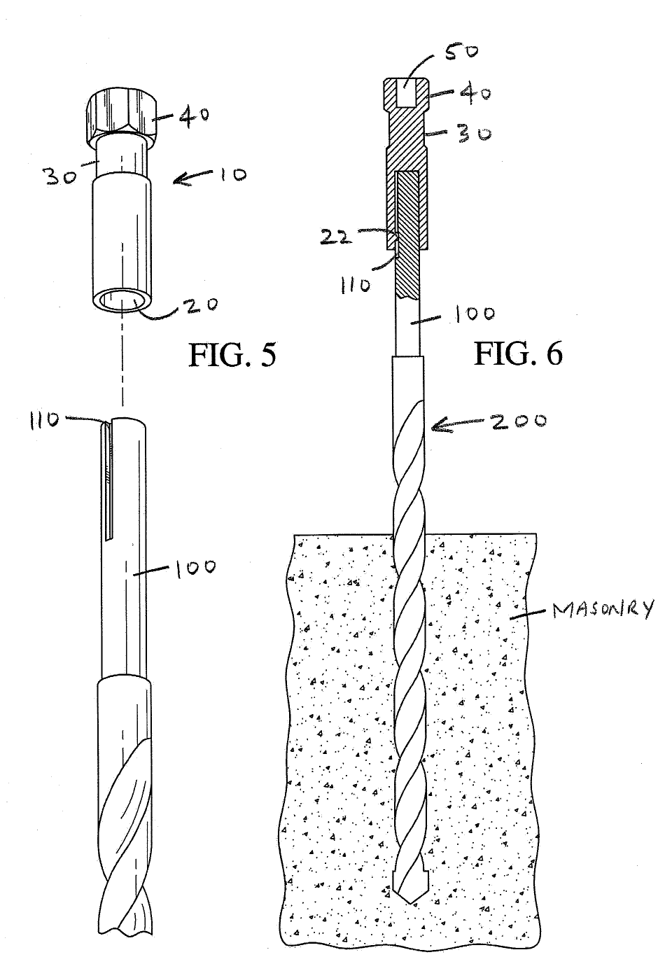

Use of the extractor apparatus can be seen in FIGS. 5 and 6. FIG. 6 shows a typical scenario with a drill bit 200 having drilled into a material such as masonry, pictured. Drill bit 200 has a shank 100 at its upper end. In this example, shank 100 has a groove 110, as can be seen in FIG. 5. Also as can be understood from FIGS. 5 and 6, extractor 10 is slid over shank 100, positioned such that projection 22 slides into groove 110, creating an interference between extractor 10 and drill bit 200, and permitting torque to be transferred between the two devices. It is understood that once extractor 10 is in place on drill bit 200, as in FIG. 6, a torque device such as a wrench, ratchet or other similar means is used to engage hexagonal torque engaging surface 40 and/or second bore 50, and apply torque to back out and extract drill bit 200.

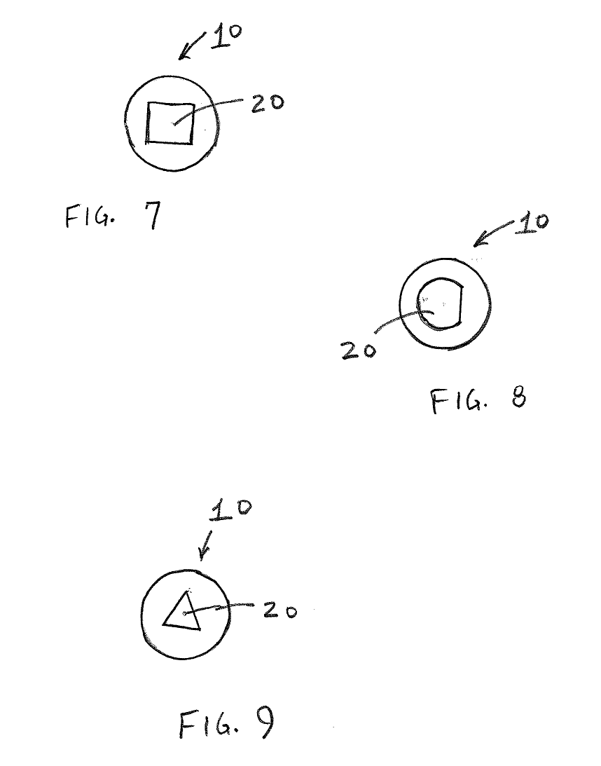

FIGS. 7-9 are cross section views of alternate cross section shapes of first bore 20. FIG. 7 is a generally square cross section; FIG. 8 is a cross section shape having at least one straight line (in this example, a partial circle, combined with a straight line); and FIG. 9 is a generally triangular cross section shape. It is to be understood that the cross section shape of first bore 20 may comprise any of these shapes. Other cross section shapes such as a splined shape are also encompassed within the scope of the invention.

As will be apparent to those having ordinary skill in the art, extractor 10 may be made from hardened steel or other like material, by machining, casting or other suitable means.

The scope of the invention encompasses an extractor having a first bore which engages a shank of a drill bit, and has one or more torque engaging surfaces to permit some form of torque device to be applied to the extractor, in order to transfer torque to the drill bit. As such, it is understood that the first bore may have an internal projection engaging a groove in the drill bit shank, as shown; or may be square, hexagonal, triangular, or other shape, engaging a similar shape of the shank of the drill bit. Likewise, any shape of the upper end and external surface of the extractor is encompassed, as long as it permits engaging a torque device thereto.

Therefore, the scope of the invention is not to be limited by the particular embodiment pictured, but by the appended claims and the legal equivalents thereof.

I claim:

1. An apparatus for applying torque to a drill bit, comprising:
an elongated main body comprising first and second ends, a first bore in one of said ends having a size and cross section shape suitable for fitting over a shank of said drill bit, said bore having a cross section shape which mates with the cross section shape of said shank and permits torque to be transferred between said main body and said drill bit, said main body further comprising a torque device engaging external surface

2. The apparatus of claim 1, wherein said torque device engaging external surface comprises at least two parallel surfaces spaced apart from one another across a diameter of said main body.

3. The apparatus of claim 2, wherein said torque device engaging external surface comprises a hexagonal cross section shape.

4. The apparatus of claim 2, wherein said torque device engaging external surface comprises a square cross section shape.

5. The apparatus of claim 1, further comprising a second bore in the end opposite said first bore, said second bore sized and shaped to receive a torque device.

6. The apparatus of claim 3, further comprising a second bore in the end opposite said first bore, said second bore sized and shaped to receive a torque device.

7. The apparatus of claim 1, wherein said first bore is generally circular in cross section shape, and comprises an internal projection to engage a slot in said shank of said drill bit.

8. The apparatus of claim 1, wherein said first bore has a cross section shape comprising at least one straight line.

9. The apparatus of claim 1, wherein said first bore has a generally triangular cross section shape.

10. An extractor for applying torque to a stuck drill bit, comprising:
an elongated main body comprising first and second ends,
a first bore disposed in one of said ends, said first bore having a size and shape suitable for fitting over a shank of said drill bit and having a cross section shape which mates with the cross section shape of said shank and permits torque to be transferred between said main body and said drill bit,
said main body further comprising an external surface having a cross section shape suitable for engaging a torque device,
said main body further comprising a second bore disposed in said end opposite said first bore, said second bore having a cross section shape adapted to engage a torque device.

11. The apparatus of claim 10, wherein said external surface comprises a hexagonal cross section shape, and wherein said second bore comprises a generally square cross section shape.

12. The apparatus of claim 11, wherein said first bore is generally circular in cross section shape, and comprises an internal projection to engage a slot in said shank of said drill bit.

13. The apparatus of claim 11, wherein said first bore has a cross section shape comprising at least one straight line.

14. The apparatus of claim 11, wherein said first bore comprises a generally square cross section shape.

15. The apparatus of claim 11, wherein said first bore has a generally triangular cross section shape.
